(19) United States
(12) Patent Application Publication
(10) Pub. No.: US 2014/0105806 A1
(43) Pub. Date: Apr. 17, 2014

(54) PROCESS FOR DEPOSITION OF POLYCRYSTALLINE SILICON

(71) Applicant: Wacker Chemie AG, Muenchen (DE)

(72) Inventor: Mikhail SOFIN, Burghausen (DE)

(73) Assignee: Wacker Chemie AG, Muenchen (DE)

(21) Appl. No.: 14/032,261

(22) Filed: Sep. 20, 2013

(30) Foreign Application Priority Data
Oct. 15, 2012 (DE) 102012218747.2

(51) Int. Cl. C01B 33/027

(52) U.S. Cl. CPC C01B 33/027
USPC 423/350

(57) ABSTRACT

The invention relates to a process for deposition of polycrystalline silicon, including introduction of a reaction gas containing a silicon-containing component and hydrogen into a reactor, as a result of which polycrystalline silicon is deposited in the form of rods, which includes passing into the reactor, after the deposition has ended, a gas which attacks silicon or silicon compounds which flows around the polycrystalline rods and an inner reactor wall in order to dissolve silicon-containing particles which are formed in the course of deposition and adhere on the inner reactor wall or on the polycrystalline silicon rods before the polycrystalline silicon rods are removed from the reactor.

### BACKGROUND OF THE INVENTION

The invention relates to a process for deposition of polycrystalline silicon.

High-purity polycrystalline silicon (polysilicon) serves as a starting material for production of monocrystalline silicon for semiconductors by the Czochralski (CZ) or zone melting (FZ) processes, and for production of mono- or polycrystalline silicon by various pulling and casting processes for production of solar cells for photovoltaics.

Polysilicon is typically produced by means of the Siemens process. This involves introducing a reaction gas comprising one or more silicon-containing components and optionally hydrogen into a reactor comprising support bodies heated by direct passage of current, silicon being deposited in solid form on the support bodies.

The silicon-containing components used are preferably silane (SiH₄), monochlorosilane (SiH₃Cl), dichlorosilane (SiH₂Cl₂), trichlorosilane (SiHCl₃), tetrachlorosilane (SiCl₄) or mixtures of the substances mentioned.

The Siemens process is typically conducted in a deposition reactor (also called “Siemens reactor”). In the most commonly used embodiment, the reactor comprises a metallic base plate and a coolable bell jar placed onto the base plate so as to form a reaction space within the bell jar. The base plate is provided with one or more gas inlet orifices and one or more offgas orifices for the departing reaction gases, and with holders which help to hold the support bodies in the reaction space and supply them with electrical current. EP 2 077 252 A2 describes the typical construction of a reactor type used in the production of polysilicon.

Each support body usually consists of two thin filament rods and a bridge which connects generally adjacent rods at their free ends. The filament rods are most commonly manufactured from mono- or polycrystalline silicon; less commonly, metals, alloys or carbon are used. The filament rods are inserted vertically into electrodes present at the reactor base, through which they are connected to the power supply. High-purity polysilicon is deposited on the heated filament rods and the horizontal bridge, as a result of which the diameter thereof increases with time. Once the desired diameter has been attained, the process is stopped by stopping the supply of silicon-containing components.

The deposition operation is typically controlled by the setting of rod temperature, reaction gas flow rate and composition. The rod temperature is measured with radiation pyrometers, usually on the surfaces of the rods facing the reactor wall. The rod temperature is set either in a fixed manner or as a function of the rod diameter by control or regulation of the electrical power. The amount and the composition of the reaction gas are set as a function of the time or the rod diameter.

The deposition with TCS or the mixture thereof with DCS and/or STC is effected typically at rod temperatures between 900 and 1100° C., a feed rate of silicon-containing component(s) of (totaling) 0.5 to 10 kmol/h per 1 m² of rod surface area, the molar proportion of this component/these components in the feed gas stream being (totaling) between 10% and 50% (the remainder, 90% to 50%, is typically hydrogen).

The figures for rod temperature here and elsewhere relate (unless mentioned explicitly) to values which are measured in the vertical rod region at least 50 cm above the electrode and at least 50 cm below the bridge. In other regions, the temperature may differ distinctly therefrom. For example, significantly higher values are measured on the inside of the bridge arc, since the current flow is distributed differently in this region.

The deposition with silane is performed at much lower temperatures (400-900° C.), flow rates (0.01 to 0.2 kmol/h of silane per 1 m² of rod surface area) and concentrations (0.5-2% silane in the hydrogen).

The morphology of the deposited rods may vary from compact and smooth (as described, for example, in U.S. Pat. No. 6,350,313 B2) as far as very porous and fissured material (as described, for example, in US2010/219380 A1). The compact rods are more expensive to produce because the operation proceeds more slowly and the specific energy consumption is higher.

The rise in the above-described base parameters (temperature of the rods, specific flow rate, concentration) generally leads to an increase in the deposition rate and hence to an improvement in the economic viability of the deposition operation.

However, natural limits are placed on each of these parameters, the exceedance of which disrupts the manufacturing operation (according to the configuration of the reactor used, the limits are somewhat different).

If, for example, the selected concentration of the silicon-containing component(s) is too high, the homogeneous gas phase deposition rises to an intolerable degree and the deposition operation is disrupted.

Generally, in the deposition of poly-Si by the Siemens process, two competing processes, silicon deposition at the surface of the rods (CVD process) and formation of free particles (gas phase reaction or dust deposition) coexist.

The nature of the particles formed differs according to the conditions of the deposition operation, configuration of the deposition reactor and site of formation, and the composition thereof may vary from pure Si (amorphous to crystalline) as far as complex silicon compounds of the general formula SiₓCl_{y}H_{z}.

The dust particles are distributed with the gas flow over the overall reactor space and are deposited on the rods and on the inner reactor wall (in the form of bell jar coating). While the particles deposited on the rods are covered with the newly forming layers with continuing deposition and thus are integrated into the material (SiₓCl_{y}H_{z} generally react at the hot rods and are converted to pure Si), the solid particles deposited on the cold bell jar wall remain suspended there in more or less their original form until the end of the deposition cycle, such that the bell jar coating becomes ever thicker with the increasing deposition time.

This necessitates cleaning of the inner wall of the deposition reactors, in which the bell jar coating is removed.

This is normally conducted after the deinstallation of the thickly deposited rods, but still before the reactor is charged with the thin filament rods for the next batch.

U.S. Pat. No. 5,108,512 A describes a process for reactor cleaning, in which carbon dioxide pellets are allowed to impact on the silicon deposits on the inner surfaces of the reactor, in order to remove the silicon deposits.

By significantly raising the H₂ content in the feed gas during the deposition, it is possible in principle to shift the equilibrium of the chemical reactions proceeding substantially to the side of the CVD operation. For economic reasons, however, this is not preferable because the deposition runs much more slowly and the energy requirement is higher under these conditions. As a result of this, the gas phase reaction is tolerated up to a certain degree in the commercial production of polysilicon.

For instance, polycrystalline silicon rods produced industrially in the Siemens process are always contaminated to a greater or lesser degree with loose silicon-containing particles or silicon dust. A portion arrives on the rods from the gas phase immediately after the end of the deposition operation. When the deposition has ended, the particles which arrive last are no longer integrated into the rods by coverage with new layers and thus remain loose on the surface. The second portion arrives unavoidably on the rods from the reactor wall, partly transferred with purge gas, partly resulting from material falling off because of agitation and movement of the reactor in the course of deinstallation.

Even a small amount of dust particles has a strong negative influence on product properties.

U.S. Pat. No. 6,916,657 discloses that extraneous particles can reduce the yield in the course of crystal cooling.

The prior art attempts to reduce the degree of the gas phase reaction by the introduction of cooling elements into the reactor space (for example DE 195 02 865 A1). As well as the very limited effect, this approach, however, means considerable additional construction complexity and generally a rise in the energy requirement, since the energy is withdrawn from the reactor by the cooling elements.

Moreover, there are several known methods in the prior art by which polycrystalline Si crushed to small pieces is freed of dust. In order to obtain chunk silicon for CZ or solar, the rods are mechanically comminuted with tools such as hammers, crushers or mills and then classified by size. The size of the silicon pieces ranges here from about 1 mm up to pieces of 150 mm or more. The shape of the pieces should typically not differ too significantly from the sphere shape.

WO 2009/003688 A2 describes, for example, a method for processing surface-contaminated silicon material present in a material mixture by sieving off the material adhering on the surface, separation of electrically conductive coarse particles from the material mixture and removal of visually recognizable extraneous material and highly oxidized silicon material from the material mixture. However, this can only achieve removal of loose and relatively large particles.

DE102010039751A1 proposes dedusting of polysilicon by means of compressed air or dry ice. As well as the considerable technical complexity, this process has the disadvantage that not all the particles can be removed in the case of porous and fissured material.

In addition, there are several known wet-chemical cleaning processes which are generally effected with one or more acids or acid mixtures (see, for example, U.S. Pat. No. 6,309,467 B1). This type of cleaning, which is normally very inconvenient and costly, likewise cannot fully remove particles present in the case of material with porous and fissured morphology.

It was an object of the present invention to find a novel inexpensive process for producing polycrystalline silicon, which frees reactor and polycrystalline silicon rods from loose particles formed in the deposition or dust and bell jar coating.

### DESCRIPTION OF THE INVENTION

The object of the invention is achieved by a process for deposition of polycrystalline silicon, comprising introduction of a reaction gas containing a silicon-containing component and hydrogen into a reactor, as a result of which polycrystalline silicon is deposited in the form of rods, which comprises passing into the reactor, after the deposition has ended, a gas which attacks silicon or silicon compounds which flows around the polycrystalline rods and an inner reactor wall in order to dissolve silicon-containing particles which are formed in the course of deposition and adhere on the inner reactor wall or on the polycrystalline silicon rods before the polycrystalline silicon rods are removed from the reactor.

The silicon compounds are compounds of the general formula SiₓCl_{y}H_{z}.

Preferably, the introduction of the gas which attacks silicon or silicon compounds is followed by purging of the reactor with hydrogen or with an inert gas (e.g. nitrogen or argon) in order to purge the reactor to free it of gaseous reaction products and unconverted residues of the silicon-containing component.

After the purging operation, the inflow of the purge gas is ended and the energy supply is reduced to zero abruptly or with a particular ramp, such that the Si rods which form cool to the ambient temperature.

It is also advantageous to conduct a similar purging operation prior to the introduction of the gas which attacks silicon or silicon compounds.

During the introduction of the gas which attacks silicon or silicon compounds, the polycrystalline silicon rods are preferably heated to a temperature of 500-1000° C. by direct passage of current.

The gas which attacks silicon or silicon compounds preferably comprises HCl. The temperature of the polycrystalline silicon rods in this case should be 500-1000° C.

It is possible to introduce a mixture of HCl and H₂ into the reactor.

It is likewise preferable to introduce a mixture of one or more chlorosilanes and H₂ as the gas which attacks silicon or silicon compounds. In this case, it is essential to select temperature of the polycrystalline silicon rods, composition of the chlorosilane/H₂ mixture and a partial flow rate of the chlorosilanes, such that the chlorosilane attacks silicon or silicon compounds.

This is the case, for example, when a mixture of H₂ and trichlorosilane or a mixture of H₂ and trichlorosilane and dichlorosilane is used, the mixture being composed of 90-99 mol % of H₂, 1-10 mol % of TCS and 0-2 mol % of DCS, the partial flow rate of the chlorosilanes totaling 0.005-0.2 kmol/h per 1 m² of a surface area of the polycrystalline silicon rods and the temperature of the polycrystalline silicon rods being 1100-1400° C.

The invention thus envisages gas-chemical removal of disruptive particles and bell jar coating in a downstream step after the end of the deposition operation.

The invention enables economically more favorable deposition operations to be run with a higher proportion of the gas phase reaction and, at the same time, high-grade, dust-and-particle-free polycrystalline rods to be obtained, which make high yields achievable in downstream crystallization steps.

In some embodiments, the bell jar coating can be fully removed, such that it is possible to dispense with reactor cleaning between the cycles. This leads to a significant time and cost saving.

It has been found that, surprisingly, measured surface metal concentrations were much lower for all batches treated in this way. Possibly, metals (or compounds thereof) are also chemically attacked at the same time, converted to the volatile chlorides and thus removed. A distinct reduction was found for Fe, Ni, Cr, Ti, Mo, Mn, Co, V, Cu, Zn, Zr, Nb, Ta, W.

Once the rods have attained the desired diameter during the deposition, a gas or gas mixture which chemically attacks and dissolves silicon dust particles and bell jar coating is passed through the reactor. This step, as mentioned above, should preferably be effected with glowing silicon rods. By setting the rod temperature, it is possible to control the cleaning action and speed.

In a first embodiment of the process, HCl gas or an HCl/H₂ mixture is passed through the reactor.

Preferably, an HCl/H₂ mixture with 20 to 80 mol % of HCl is to be used.

More preferably, the partial flow rate of the hydrogen chloride is 0.001 to 0.1 kmol/h per 1 m² of surface area of the silicon rods.

Most preferably, rod temperature should be set here to 500-1000° C.

The duration of the operation is guided by the degree of contamination of the rods and bell jar.

In practice, the periods between 10 and 90 minutes have been found to be optimal.

In addition, the significant bell jar coating can also be fully removed, such that it is possible to dispense with cleaning of the bell jar between the cycles.

A disadvantage is that polysilicon rods are also attacked and dissolved to a minor degree by HCl. This leads to a certain reduction in yield.

In a second embodiment, a mixture of one or more chlorosilanes (such as silicon tetrachloride, trichlorosilane, dichlorosilane) and H₂ is passed through the reactor.

In this case, the deposited silicon rods are attacked only to a very small degree, if at all.

In the case of suitable selection of the operating parameters, in addition to the corrosive effect with respect to bell jar coating and loose silicon particles, a minor degree of additional deposition of silicon on the silicon rods is possible at the same time.

A further advantage of this second embodiment is the possibility of using the same chlorosilane or the same mixture of chlorosilanes which is used for the deposition for the cleaning.

Thus, there is no need to lay any further lines to the reactors in order to supply them with the medium for the cleaning.

Particular preference is given to the use of a mixture of H₂ and trichlorosilane or of a mixture of H₂, trichlorosilane and dichlorosilane with a composition of H₂ 90-99 mol %, TCS 1-10 mol % and DCS 0-2 mol %. Preferably, the partial flow rate of the chlorosilanes totals between 0.005 and 0.2 kmol/h per 1 m² of surface area of the silicon rods. Most preferably, the temperature of the silicon rods here is between 1100 and 1400° C.

The duration of the operation is guided by the degree of contamination of the rods and bell jar.

In practice, periods between 30 and 600 minutes have been found to be optimal.

It is also possible to combine the two approaches described in various ways.

### EXAMPLES

The advantages of the invention are to be illustrated hereinafter by a comparative example and by examples.

These involved producing polycrystalline silicon rods (diameter 160 mm) each in the same deposition reactor with the same deposition operation, which features a high deposition rate and economic viability but also has a proportion of gas phase reaction, such that significant bell jar coating is formed and the rods are contaminated with loose particles:

The deposition was performed with TCS and H₂ at a rod temperature of 1050° C. constant over the entire deposition time. The molar proportion of TCS was 30%. The feed thereof was regulated as a function of the rod diameter such that the specific flow rate was 3 kmol/h per 1 m² of rod surface area.

To measure the bell jar coating which formed, the degree of reflection of the inner bell jar wall before and after the deposition was measured at 900 mm with a photometer.

To assess the quality of the rods, they were comminuted after the deposition and finally used in a CZ crystal pulling operation.

To assess the pulling performance, the proportion by weight of the polycrystalline silicon which was convertible to a dislocation-free single crystal was determined in each case (pulling yield).

A high pulling yield indicates low contamination and high quality of the rods.

In all experiments, single silicon crystals were pulled in the following CZ pulling operation: starting crucible weight 90 kg, crystal diameter 8 inches, crystal orientation <100>, pulling speed 1 mm/h.

### COMPARATIVE EXAMPLE

In the comparative example, the rods were not subjected to any treatment after the deposition. The reactor was purged clear in accordance with the prior art. Subsequently, the rods deposited were cooled to room temperature and deinstalled.

The measurement of the reflection of the reactor wall after the end of the process showed a reduction by 50% compared to the reflection of a clean bell jar before the start of the process.

The pulling of single crystals from the polycrystalline material obtained gave a pulling yield averaging only 67.3%.

### Example 1

In example 1, after deposition and purging of the reactor, the rods and the reactor were subjected to an inventive cleaning step according to the first embodiment.

This involved passing a gas mixture of HCl (50 mol %) and H₂ through the reactor for 30 minutes, in the course of which the partial flow rate of the hydrogen chloride was 0.01 kmol/h per 1 m² of surface area of the silicon rods and the temperature of the rods was 700° C.

Through the measurement of the reflection of the reactor wall after this step, it was not possible to find any reduction compared to the original clean state before the deposition, which indicates that the bell jar coating, as was found in the comparative example, has been fully removed.

The pulling of single crystals from the polycrystalline material obtained gave a pulling yield averaging 93.3%.

### Example 2

In example 2, after deposition and purging of the reactor, the rods and the reactor were subjected to an inventive cleaning step according to the second embodiment.

This involved passing a gas mixture of TCS (5 mol %) and H₂ through the reactor for 300 minutes, in the course of which the partial flow rate of the chlorosilane was 0.05 kmol/h per 1 m² of surface area of the silicon rods and the temperature of the rods was 1200° C.

The measurement of the reflection of the reactor wall after this step showed a small decrease to 95%, compared to the reflection of a clean bell jar before the start of the deposition.

The pulling of single crystals from the polycrystalline material obtained gave a pulling yield averaging 91.8%.

What is claimed is:

1. A process for deposition of polycrystalline silicon, comprising:
(a) introduction of a reaction gas containing a silicon-containing component and hydrogen into a reactor so as to deposit polycrystalline silicon rods, and
(b) passing into the reactor, after the deposition has ended, a gas which attacks silicon or silicon compounds which flows around the polycrystalline silicon rods and an inner reactor wall in order to dissolve silicon-containing particles which are formed in the course of deposition and adhere on an inner reactor wall or on the polycrystalline silicon rods before the polycrystalline silicon rods are removed from the reactor.

2. The process as claimed in claim 1, wherein the introduction of the gas which attacks silicon or silicon compounds is followed by purging of the reactor with hydrogen or with an inert gas in order to purge the reactor free of gaseous reaction products and unconverted residues of the silicon-containing component.

3. The process as claimed in claim 2, wherein the introduction of the gas which attacks silicon or silicon compounds is also preceded by purging of the reactor with hydrogen or with an inert gas.

4. The process as claimed in claim 1, wherein the polycrystalline silicon rods are heated to a temperature of 500-1000° C. by direct passage of current during the introduction of the gas which attacks silicon or silicon compounds.

5. The process as claimed in claim 1, wherein the gas which attacks silicon or silicon compounds comprises HCl and a temperature of the polycrystalline silicon rods is 500-1000° C.

6. The process as claimed in claim 5, wherein the gas which attacks silicon or silicon compounds used is a mixture of HCl and H₂.

7. The process as claimed in claim 1, wherein the gas which attacks silicon or silicon compounds introduced is a mixture of one or more chlorosilanes and H₂, with selection of temperature of the polycrystalline silicon rods, composition of the chlorosilane/H₂ mixture and a partial flow of the chlorosilane such that the chlorosilane attacks silicon or silicon compounds.

8. The process as claimed in claim 7, wherein a mixture of H₂ and trichlorosilane or a mixture of H₂ and trichlorosilane and dichlorosilane is used, the mixture comprising 90-99 mol % of H₂, 1-10 mol % of TCS and 0-2 mol % of DCS, a partial flow rate of the chlorosilanes totaling 0.005-0.2 kmol/h per 1 m² of a surface area of the polycrystalline silicon rods and the temperature of the polycrystalline silicon rods being 1100-1400° C.

9. The process as claimed in claim 2, wherein the polycrystalline silicon rods are heated to a temperature of 500-1000° C. by direct passage of current during the introduction of the gas which attacks silicon or silicon compounds.

10. The process as claimed in claim 3, wherein the polycrystalline silicon rods are heated to a temperature of 500-1000° C. by direct passage of current during the introduction of the gas which attacks silicon or silicon compounds.

11. The process as claimed in claim 2, wherein the gas which attacks silicon or silicon compounds comprises HCl and a temperature of the polycrystalline silicon rods is 500-1000° C.

12. The process as claimed in claim 3, wherein the gas which attacks silicon or silicon compounds comprises HCl and a temperature of the polycrystalline silicon rods is 500-1000° C.

13. The process as claimed in claim 4, wherein the gas which attacks silicon or silicon compounds comprises HCl and a temperature of the polycrystalline silicon rods is 500-1000° C.

14. The process as claimed in claim 2, wherein the gas which attacks silicon or silicon compounds introduced is a mixture of one or more chlorosilanes and H₂, with selection of temperature of the polycrystalline silicon rods, composition of the chlorosilane/H₂ mixture and a partial flow of the chlorosilane such that the chlorosilane attacks silicon or silicon compounds.

15. The process as claimed in claim 3, wherein the gas which attacks silicon or silicon compounds introduced is a mixture of one or more chlorosilanes and H₂, with selection of temperature of the polycrystalline silicon rods, composition of the chlorosilane/H₂ mixture and a partial flow of the chlorosilane such that the chlorosilane attacks silicon or silicon compounds.

16. The process as claimed in claim 4, wherein the gas which attacks silicon or silicon compounds introduced is a mixture of one or more chlorosilanes and H₂, with selection of temperature of the polycrystalline silicon rods, composition of the chlorosilane/H₂ mixture and a partial flow of the chlorosilane such that the chlorosilane attacks silicon or silicon compounds.

17. The process as claimed in claim 10, wherein the gas which attacks silicon or silicon compounds comprises HCl and a temperature of the polycrystalline silicon rods is 500-1000° C.

18. The process as claimed in claim 17, wherein the gas which attacks silicon or silicon compounds used is a mixture of HCl and H₂.

19. The process as claimed in claim 10, wherein the gas which attacks silicon or silicon compounds introduced is a mixture of one or more chlorosilanes and H₂, with selection of temperature of the polycrystalline silicon rods, composition of the chlorosilane/H₂ mixture and a partial flow of the chlorosilane such that the chlorosilane attacks silicon or silicon compounds.

20. The process as claimed in claim 19, wherein a mixture of H₂ and trichlorosilane or a mixture of H₂ and trichlorosilane and dichlorosilane is used, the mixture comprising 90-99 mol % of H₂, 1-10 mol % of TCS and 0-2 mol % of DCS, a partial flow rate of the chlorosilanes totaling 0.005-0.2 kmol/h per 1 m² of a surface area of the polycrystalline silicon rods and the temperature of the polycrystalline silicon rods being 1100-1400° C.
